(19) United States
(12) Patent Application Publication
(10) Pub. No.: US 2005/0212972 A1
(43) Pub. Date: Sep. 29, 2005

(54) Noise reduction device and television receiver

(75) Inventor: Takashi Suzuki, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/089,022

(22) Filed: Mar. 25, 2005

(30) Foreign Application Priority Data
Mar. 26, 2004 (JP) 2004/93503

(51) Int. Cl. H04N 5/213

(52) U.S. Cl. 348/607

(57) ABSTRACT

A noise reduction circuit performs noise reduction by an arithmetic operation on an input video signal and its one-frame delayed video signal. At that time, a noise reduction level is always maintained at a constant value that suppresses a trail behind a moving image. An aperture correction circuit performs image-quality correction by using a high frequency component extracted from the video signal as a correction signal. When a detection level of a noise detection circuit exceeds a predetermined value, the level of the correction signal is controlled to decrease. A velocity modulation circuit supplies the high frequency component extracted from the video signal to an auxiliary deflecting coil of a cathode ray tube as a scanning velocity modulation signal so as to perform image-quality correction. When a detection level of the noise detection circuit exceeds a predetermined value, the level of the scanning velocity modulation signal is controlled to decrease.

### CROSS-REFERENCE TO RELATED APPLICATIONS

This application is based upon and claims the benefit of priority from the prior Japanese Patent Application No. 2004-93503 filed on Mar. 26, 2004; the entire contents of which are incorporated herein by reference.

### BACKGROUND OF THE INVENTION

1. Field of the Invention

The present invention relates to a noise reduction device of a video signal in video equipment, such as a television receiver, and a television receiver.

2. Description of the Related Art

In general, in a noise reduction function of a television receiver, a noise level of an input video signal is detected and the noise reduction ratio is controlled in accordance with the detected noise level.

To detect the noise, a predetermined portion of the input video signal in a vertical blanking interval is retrieved by a gate circuit. The amplitude value of that portion of the signal is detected by a detection circuit and is output as a detection value. Since the blanking interval contains no video component, the detected signal amplitude level can be considered as a noise detection value.

A known technology, for example, Japanese Unexamined Patent Application Publication No. 2000-196916 discloses a method in which a component regarded as noise is reduced by an arithmetic operation.

In this publication, an automatic gain control circuit automatically controls the amplitude of a video signal output from an image pickup device. A subtracter subtracts a video signal of the preceding frame or of the preceding field from the current video signal output from the automatic gain control circuit. The resultant value is limited by a predetermined value. Subsequently, a multiplier multiplies the value by a predetermined coefficient (i.e., gain). An adder adds that value to the video signal of the current field. In this process, the value for the limitation is controlled in accordance with a gain value of the automatic gain control circuit to reduce the noise of the video signal. As the gain of the automatic gain control (AGC) increases, the value for the limitation increases. Accordingly, this method can prevent a residual image (a trail behind a moving image) from increasing when the gain of the AGC is small. Also, this method can increase the noise reduction effect when the gain of the AGC is large.

On the other hand, as the gain of the adder circuit increases to 1, the subtracting value of a non-correlated component increases. Therefore, the noise is further removed. However, since a moving picture component in the signal is also considered as noise, the moving picture component is viewed as an image having a trail behind it when the gain is increased. Thus, since the trail becomes distinct for a signal having less noise, the gain cannot be increased so much. To solve this problem, the gain may be controlled in conjunction with the above-described noise detection function. In this case, the noise level of an input signal is detected. If the gain decreases when the noise is low and if the gain increases when the detected noise is high, a trail becomes distinct when the gain increases, although the noise reduction effect increases.

As described above, in the method disclosed in Japanese Unexamined Patent Application Publication No. 2000-196916, the limit value is set to a large value when the gain of the AGC is large. Consequently, a feedback value increases, and therefore, the noise reduction effect can be increased. The limit value is set to a small value when the gain of the AGC is small. Consequently, a residual image can be suppressed. However, when the gain of the AGC is large, a trail behind a moving image becomes large.

Additionally, depending on signal conditions, for example, when receiving a terrestrial broadcast, a noise detection value often exhibits a value larger than the actual noise level due to a pre-ghost image. In this case, the gain control using a result of the noise detection excessively controls a noise reduction unit. In particular, a noise reduction unit using an arithmetic operation produces a trail behind a moving image, thus considerably deteriorating the visual image. Therefore, in some cases of the noise reduction unit using an arithmetic operation, the level should be fixed to a certain level that produces no trail at all times although the noise reduction effect is reduced.

### BRIEF SUMMARY OF THE INVENTION

Accordingly, it is an object of the present invention to provide a noise reduction device and a television receiver that allow effective noise reduction without a trail behind a moving image caused by excessive control of noise reduction unit depending on signal conditions.

According to an embodiment of the present invention, in order to solve the above-described problem, a level of the noise reduction unit by an arithmetic operation is maintained at a certain level at all times. A noise detection value is controlled by using a correction-signal level of an aperture correction unit for correcting the frequency characteristic and a scanning velocity modulation signal level of a velocity modulation unit.

According to an embodiment of the present invention, a noise reduction device includes a noise reduction unit which reduces noise by carrying out an arithmetic operation on an input video signal and one of a frame-delayed signal and a field-delayed signal of the video signal, a unit which maintains the noise reduction unit at a constant noise reduction level at all times, a noise detection unit which detects a noise level of the video signal, an aperture correction unit which corrects image quality using a high-frequency component extracted from the video signal as a correction signal, a velocity modulation unit which corrects image quality by supplying the high-frequency component extracted from the video signal to an auxiliary deflecting coil of a cathode ray tube as a scanning velocity modulation signal, and a control unit which controls a level of the correction signal of the aperture correction unit and a level of the scanning velocity modulation signal of the velocity modulation unit in accordance with the detection level of the noise detection unit.

Preferably, in the noise reduction device, the control unit controls a level of a correction signal of the aperture correction unit and a level of the scanning velocity modulation signal of the velocity modulation unit so as to decrease the levels when the detection level of the noise detection unit is higher than a predetermined value and so as to increase the levels when the detection level of the noise detection unit is lower than a predetermined value.

According to the embodiment of the present invention, for the noise reduction unit by an arithmetic operation, a gain of a constant level at all times is set so as to suppress a trail behind a moving image. The shortage of noise reduction is compensated by a gain control of a frequency correction using a high-frequency component and a gain control of velocity modulation. As a result, the noise reduction effect can be maintained without a trail behind a moving image.

According to an embodiment of the present invention, a television receiver includes a cathode ray tube including a deflecting coil and an auxiliary deflecting coil for scanning velocity modulation, a noise reduction circuit which reduces noise by carrying out an arithmetic operation on an input video signal and one of a frame-delayed signal and a field-delayed signal of the video signal and maintains a noise reduction level to be a constant value, a noise detection circuit which detects a noise level of the video signal, an aperture correction circuit which corrects image quality using a high-frequency component extracted from the video signal as a correction signal, a velocity modulation circuit which corrects image quality by supplying a high-frequency component extracted from the video signal to the auxiliary deflecting coil as a scanning velocity modulation signal, and a control circuit which controls a level of the correction signal of the aperture correction circuit and a level of the scanning velocity modulation signal of the velocity modulation circuit in accordance with the detection level of the noise detection circuit.

Preferably, in the television receiver, the noise detection circuit detects a video level during an inactive video period of the video signal.

Preferably, in the television receiver, the aperture correction circuit includes an extraction circuit which extracts a high-frequency component from a video signal, a first gain control circuit which is connected in series to the extraction circuit, and an adder which adds the high-frequency component corrected by the first gain control circuit to the video signal, and the aperture correction circuit controls a gain of the first gain control circuit in response to a control signal from the control circuit.

Preferably, in the television receiver, the velocity modulation circuit includes a differentiating circuit which differentiates a high-frequency component of a video signal and a second gain control circuit which is connected in series to the differentiating circuit, and the velocity modulation circuit controls a gain of the second gain control circuit in response to a control signal from the control circuit so as to control a differential output level.

According to embodiments of the present invention, for the noise reduction unit by an arithmetic operation, a gain of a constant level at all times is set so as to suppress a trail behind a moving image. The shortage of noise reduction is compensated by a gain control of a frequency correction using a high-frequency component and a gain control of velocity modulation. As a result, the noise reduction effect can be maintained without a trail behind a moving image caused by the noise reduction unit depending on signal conditions.

According to an embodiment of the present invention, a noise reduction unit which reduces a noise components signal from an input video signal in a constant gain, the noise components signal is extracted by difference between current input signal and a preceding video signal; a detection unit which detects a noise level of the input video signal; a correction unit which corrects image quality using a high-frequency component extracted from the video signal as an outline enhancement correction signal; a modulation unit which corrects image quality by supplying the high-frequency component extracted from the video signal to an auxiliary deflecting coil of a cathode ray tube as a scanning velocity modulation signal; and a control unit which controls a correction gain of at least one of the correction unit or the velocity modulation unit so as to inverse proportion to noise level.

### BRIEF DESCRIPTION OF THE DRAWINGS

FIG. 1 is a block diagram of a noise reduction device according to a first embodiment of the present invention;

FIG. 2 is a block diagram of a noise detection circuit;

FIG. 3 is a block diagram of a noise reduction circuit;

FIG. 4 is a block diagram of an aperture correction circuit; and

FIG. 5 is a block diagram of a differentiating circuit in a velocity modulation circuit.

### DETAILED DESCRIPTION OF THE INVENTION

Embodiments of the present invention will be described below with reference to the accompanying drawings.

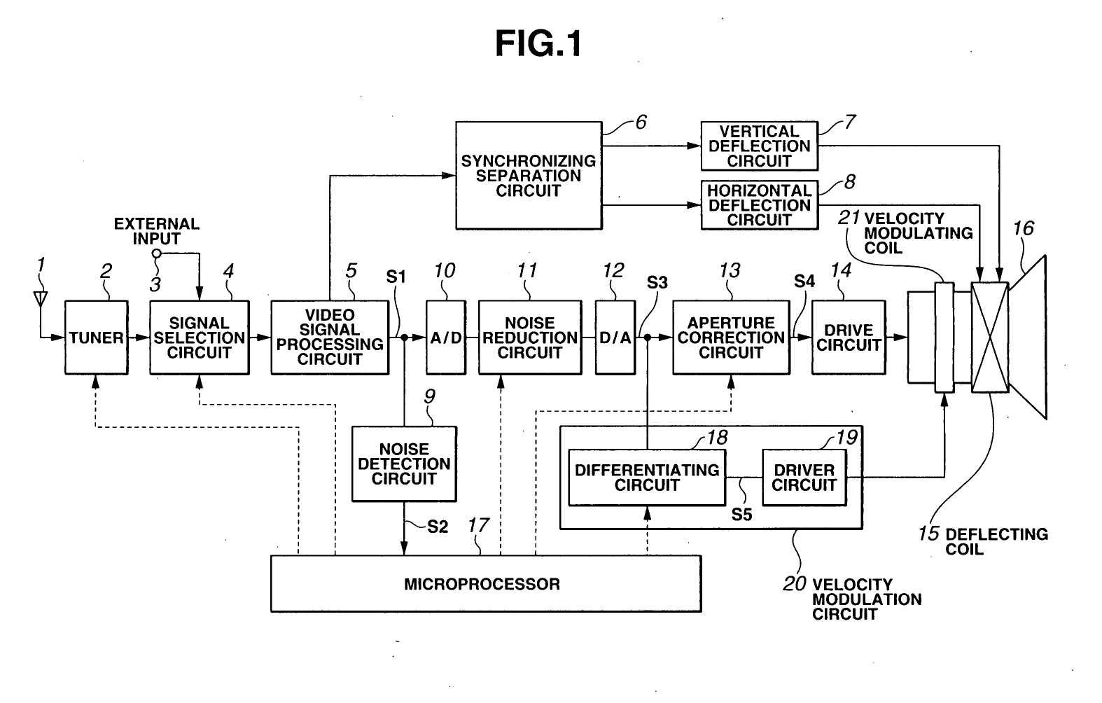

FIG. 1 is a block diagram of a noise reduction device according to a first embodiment of the present invention. In the first embodiment, a noise reduction device of a television receiver will be described.

As shown in FIG. 1, the noise reduction device of the television receiver includes an antenna 1, a tuner 2, an external input terminal 3, a signal selection circuit 4, a video signal processing circuit 5, a synchronizing separation circuit 6, a vertical deflection circuit 7, a horizontal deflection circuit 8, a noise detection circuit 9, an A/D converter 10, a noise reduction circuit 11, a D/A converter 12, an aperture correction circuit 13, a drive circuit 14, a deflecting coil 15, a cathode ray tube 16, a microprocessor 17 functioning as a control unit, a velocity modulation circuit 20 composed of a differentiating circuit 18 and a drive circuit 19, and a velocity modulation coil 21.

The tuner 2 tunes in to and receives a television broadcasting signal input from the antenna 1, and inputs it to one input terminal of the signal selection circuit 4. A video signal from external video equipment (not shown) connected to the external input terminal 3 is input to the other input terminal of the signal selection circuit 4. The signal selection circuit 4 selects and outputs one of the two input signals based on a selection signal from the microprocessor 17. The microprocessor 17 receives a command signal from an operation unit (not shown) in accordance with a user operation using a channel selection key and an input selection key. Thus, the microprocessor 17 provides a control signal for channel selection and input selection based on the operation of the user to the tuner 2 and the signal selection circuit 4.

The video signal processing circuit 5 includes a wave detector circuit, a video amplifier circuit, and an AGC circuit. The video signal after the wave detection is video-amplified and is input to the synchronizing separation circuit 6 to separate a vertical synchronization signal from a horizontal synchronization signal. Then, the vertical synchronization signal and horizontal synchronization signal are input to the vertical deflection circuit 7 and the horizontal deflection circuit 8, respectively, which generate a vertical deflection signal and a horizontal deflection signal to be inputted to vertical and horizontal deflecting coils 15 of a deflection yoke.

Also, the video signal after the wave detection is video-amplified and is input to the noise detection circuit 9 while being converted to a digital signal with the A/D converter 10 to input to the noise reduction circuit 11. The noise reduction circuit 11 reduces noise in the video signal. Then, the D/A converter 12 converts the signal to an analog form again and outputs it.

The noise detection circuit 9 acquires a noise detection value by detecting an average level or a peak level during an inactive video period of the video signal after the wave detection, for example, during a certain period in a vertical blanking interval. The noise detection circuit 9 then supplies the noise detection value to the microprocessor 17. Detecting noise may be carried out based on the analog signal. Alternatively, the noise may be detected based on the digital signal output from the A/D converter 10.

The noise reduction circuit 11 is a digital circuit which reduces a noise component by an arithmetic operation. As shown in FIG. 3, the noise reduction circuit 11 includes, for example, an adder 41, a one-frame delay circuit 42, a subtracter 43, a limit circuit 44, and a multiplier 45. The noise reduction circuit 11 carries out a subtraction process between a one-frame delayed video signal stored in the one-frame delay circuit 42 and a current video signal to extract a noise component having no correlation. By adding the non-correlated noise component to the current video signal, a video signal whose noise component is subtracted is obtained. This process is repeated several times so as to remove non-correlated components of the video signal, namely, noise components. FIG. 3 will be described in detail below.

The video signal whose noise is reduced by the noise reduction circuit 11 using an arithmetic operation is converted to an analog signal by the D/A converter 12 and is then delivered to the aperture correction circuit 13 for enhancing the outline of an image. The video signal is also delivered to the velocity modulation circuit 20 for enhancing an image by modulating a horizontal scanning velocity of an electron beam of the cathode ray tube 16.

Both the aperture correction circuit 13 and the velocity modulation circuit 20 can carry out noise reduction by decreasing an image-quality correction function of the video signal, that is, by decreasing frequency components that distinctly enhances the noise among the frequency components of the signal. For example, an image-quality correction function, such as an aperture correction, enhances frequency components that distinctly appear in a visual effect. In other words, the function most distinctly emphasizes noise. Accordingly, by decreasing the effect of the function, visual noise can be significantly reduced.

The video signal aperture-corrected by the aperture correction circuit 13 is delivered to the drive circuit 14, which is a video output circuit and a downstream circuit of the cathode ray tube 16. An image signal output from the drive circuit 14 is input to a cathode of the cathode ray tube 16, and an image is displayed on a fluorescent screen of the cathode ray tube 16 by varying the traveling velocity of the electron beam in accordance with the amplitude of the video signal.

The velocity modulation circuit 20 is composed of the differentiating circuit 18 and the drive circuit 19. The differentiating circuit 18 differentiates the video signal and the drive circuit 19 amplifies the differentiated signal to deliver it to the velocity modulation coil 21, which is an auxiliary deflecting coil disposed on the circumference of a neck section of the cathode ray tube 16. Thus, scanning velocity at the edge of the image is varied so as to carry out image enhancing.

The microprocessor 17 controls a coefficient of the multiplier of the noise reduction circuit 11 (i.e., the feedback coefficient K), an amount of aperture correction of the aperture correction circuit 13 (i.e., a frequency correction level), and a velocity modulation gain of the velocity modulation circuit 20 (i.e., a gain of an output stage of the differentiating circuit 18) in accordance with a noise detection value of the noise detection circuit 9.

The microprocessor 17 controls the gains of the noise reduction circuit 11, the aperture correction circuit 13, and the velocity modulation circuit 20 in accordance with a noise detection value of the noise detection circuit 9. In the embodiment of the present invention, the multiplier coefficient (feedback coefficient K) of the noise reduction circuit 11 is maintained at a certain level at all times in order to decrease a trail behind a moving image. Accordingly, the multiplier coefficient of the noise reduction circuit 11 need not be controlled in accordance with a noise detection value of the noise detection circuit 9. The amount of aperture correction (a frequency correction level) of the aperture correction circuit 13 and the velocity modulation gain of the velocity modulation circuit 20 are controlled so as to change the gains in accordance with a noise detection value of the noise detection circuit 9. That is, if a noise level of the input video signal increases to exceed a predetermined value, the amount of aperture correction and a velocity modulation gain are controlled so as to decrease.

The operation of the embodiment of the present invention will be described next with reference to a block diagram of FIG. 1.

As shown in FIG. 1, a video signal S1 of a baseband output from the video signal processing circuit 5 is input to the noise detection circuit 9. The noise detection circuit 9 detects a part of a flat amplitude level during a vertical blanking interval, which is an inactive video period of the video signal. Since a level in this part is flat, the average value or a peak value of the signal level in this period can be considered as a noise detection value. This result of the noise detection is transmitted to the microprocessor 17.

The video signal S1 is input via the A/D converter 10 to the noise reduction circuit 11 which carries out noise reduction by an arithmetic operation. The operation will be described in detail with reference to FIG. 3. In the noise reduction circuit 11, a control terminal 46 of the multiplier 45, which is a gain setting unit for determining a noise reduction level, is connected to the microprocessor 17 and a control signal of a constant level is provided to the control terminal 46 at all times. Alternatively, if the control terminal 46 is removed from the multiplier 45, the multiplier coefficient of the multiplier 45 is set to a constant value determined by circuit elements and a power supply voltage. A video signal S3, which is a signal whose noise is reduced by an arithmetic operation of the noise reduction circuit 11 and is converted to an analog form by the D/A converter 12, is input to the aperture correction circuit 13 and the differentiating circuit 18 for modulating a velocity. Both aperture correction circuit 13 and differentiating circuit 18 for modulating a velocity function as an image-quality correction unit.

The aperture correction circuit 13 adds a correction signal for enhancing the outline, which is a differentiated value of the video signal S3, to the original video signal S3 in order to correct the frequency. The level of the correction signal for enhancing the outline is controlled by the microprocessor 17 in accordance with a noise detection value. In the output stage of the differentiating circuit 18 in the velocity modulation circuit 20, a level of the differentiated signal for modulating a horizontal scanning velocity is also controlled by the microprocessor 17 in accordance with the noise detection value.

The velocity modulation circuit 20 amplifies a differential component of the video signal output from the differentiating circuit 18 by using the drive circuit 19 and converts it to an electric current. By the electric current flowing in the velocity modulation coil 21 wound around the neck of the cathode ray tube 16, the velocity of the raster scan is modulated with the video differential component, and therefore, the outline of the video image on the cathode ray tube 16 is enhanced. However, in the case where a video signal contains many noise components, the velocity modulating function of the velocity modulation circuit 20 sometimes exhibits negative effect since the outline of noise is enhanced. Accordingly, in order to reduce noise in a noisy signal, it is effective to decrease the gain of the velocity modulation.

In the embodiment according to the present invention, when a detection value of the noise detection circuit 9 becomes small, the microprocessor 17 controls the aperture correction circuit 13 so as to increase the gain of the correction signal to increase the correction value, so that a high-frequency correction value of the video signal is increased. Similarly, when a detection value of the noise detection circuit 9 becomes small, the microprocessor 17 controls the velocity modulation circuit 20 so as to increase the gain of a velocity modulation signal to increase the output level of the velocity modulation.

On the other hand, when a detection value of the noise detection circuit 9 becomes large, the microprocessor 17 controls the aperture correction circuit 13 and the velocity modulation circuit 20 so as to decrease the aperture correction value and the gain of the velocity modulation. Therefore, a noise component is not visually emphasized by aperture correction and velocity modulation. Additionally, since the value of noise reduction by an arithmetic operation is constant, a trail behind a moving image is completely eliminated.

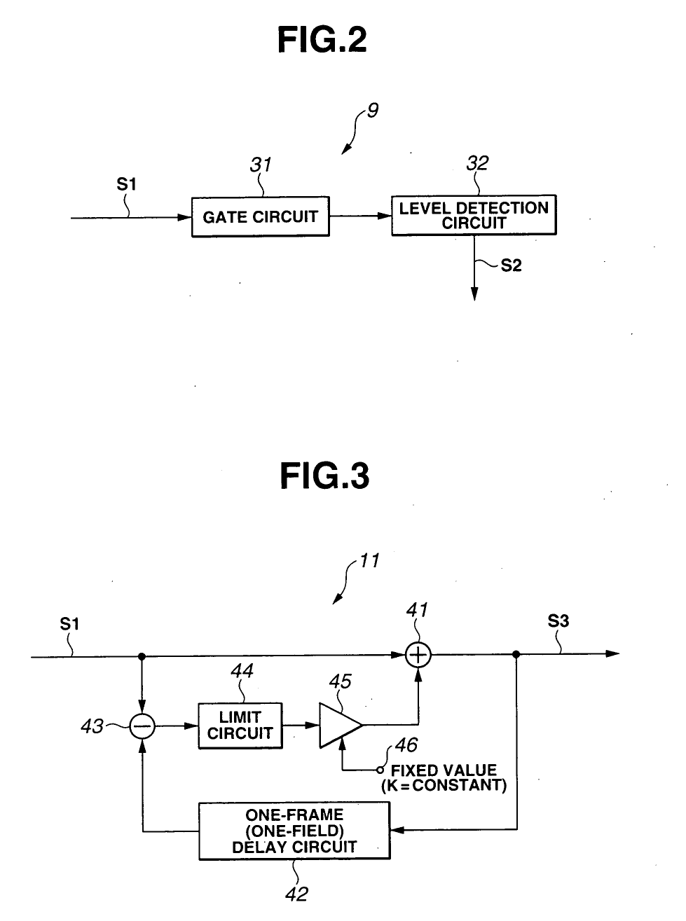

FIG. 2 is a block diagram of the noise detection circuit 9.

As shown in FIG. 2, the noise detection circuit 9 includes a gate circuit 31 for retrieving an inactive video period of the video signal S1 and a level detection circuit 32 for detecting a signal level during the retrieved inactive video period.

In this configuration, the gate circuit 31 retrieves an inactive video period of the video signal S1, for example, a certain period in a vertical blanking interval. The level detection circuit 32 detects a signal amplitude value during the certain period and outputs it as a level detection value S2. Here, the blanking interval contains no video component, and therefore, the detected signal amplitude level is regarded as a noise detection value.

FIG. 3 is a block diagram of the noise reduction circuit 11.

In FIG. 3, the noise reduction circuit 11 is a circuit that reduces noise components by using the fact that an interlace video signal has correlation between frames and a noise component has no correlation between frames. The noise reduction circuit 11 includes the one-frame delay circuit 42 composed of the adder 41 and a frame memory, the subtracter 43, the limit circuit 44, and the multiplier 45 which is a gain setting unit. The multiplier 45 has the control terminal 46, through which a control signal can control the multiplier coefficient (feedback coefficient K). According to the embodiment of the present invention, since a control value for the control terminal 46 remains constant, the control terminal 46 may be eliminated if the multiplier coefficient can be set inside the multiplier 45.

In such a configuration, if the video signal is an interlace signal, a video signal of a preceding frame (i.e., a one-frame delayed video signal by the one-frame delay circuit 42) is subtracted by the current video signal with the subtracter 43. Since the subtracted signal is a non-correlated component between frames and is regarded as a noise component, the noise component can be reduced by adding the subtracted signal to the current video signal with the adder 41 after the subtracted signal goes through the limit circuit 44 and the multiplier 45. Additionally, if the video signal is a non-interlace signal, the video signal has correlation between fields and the noise component has no correlation between the fields. Accordingly, a one-field delay circuit having a field memory may be used in place of the one-frame delay circuit 42.

The limit circuit 44 limits an output signal level greater than a predetermined level to the predetermined level (a limit value), and limits a feedback value for a moving image (in this case, the output of the subtracter 43 becomes large) so as to suppress a residual image, which is a drawback of a noise reduction circuit. In terms of the residual image, for a completely stationary image, the subtracter 43 outputs only a noise component. For a moving image, the output of subtracter 43 contains a difference of video components between a video signal of the preceding frame and the current video signal. The residual image occurs since the signal containing the difference of the video is added to the current video signal.

The multiplier 45 multiplies a signal by the feedback coefficient K (0≦K<1). As K increases to 1, the noise reduction effect becomes larger. However, a residual image of a moving image (a trail behind the moving image) also becomes larger. Accordingly, in the embodiment of the present invention, the feedback coefficient K is fixed to an appropriate constant value. The limit value of the limit circuit 44 is also fixed to an appropriate constant value. That is, the feedback coefficient K is maintained under a predetermined value in order to obtain the best noise reduction effect and the best residual image status.

The subtracter 43 outputs a difference signal between a frame-delayed (or field-delayed) video signal output from the one-frame delay circuit 42 and the input video signal. The adder 41 outputs a sum between the original input video signal and the difference signal which comes through the limit circuit 44 and the multiplier 45. In a circuit shown in FIG. 3, the input video signal is added to an output signal from the multiplier 45 with the adder 41. Since the output signal from the multiplier 45 has no correlation between a frame and its previous frame, adding with the adder has the same meaning as subtracting. Therefore, a subtracter in place of the adder 41 provides the same effect. In this case, a first difference signal output from the subtracter 43 is a signal having no correlation between frames, that is, a noise component. Accordingly, in the adder 41, the sum between the noise component signal and the original signal is a result that a noise component of the original signal is subtracted from the original signal by adding the noise component signal and the original signal. The video signal whose noise component is subtracted is input to the one-frame delay circuit 42 again. By repeating this cyclic operation, non-correlated components, namely, noise components of the video signal are reduced. When setting a coefficient of the multiplier 45 before obtaining a second difference, as the coefficient K increases to 1, a subtraction value of non-correlated component becomes larger and the noise reduction effect becomes larger. However, a moving-image component in the signal is regarded as noise. Accordingly, as the coefficient increases, the moving-image component is viewed as a trail behind the moving image. In the case of a video signal of a moving image, a trail behind the moving image becomes distinct for a video signal having less noise. Thus, the coefficient K is set to an appropriate constant value that suppresses the trail.

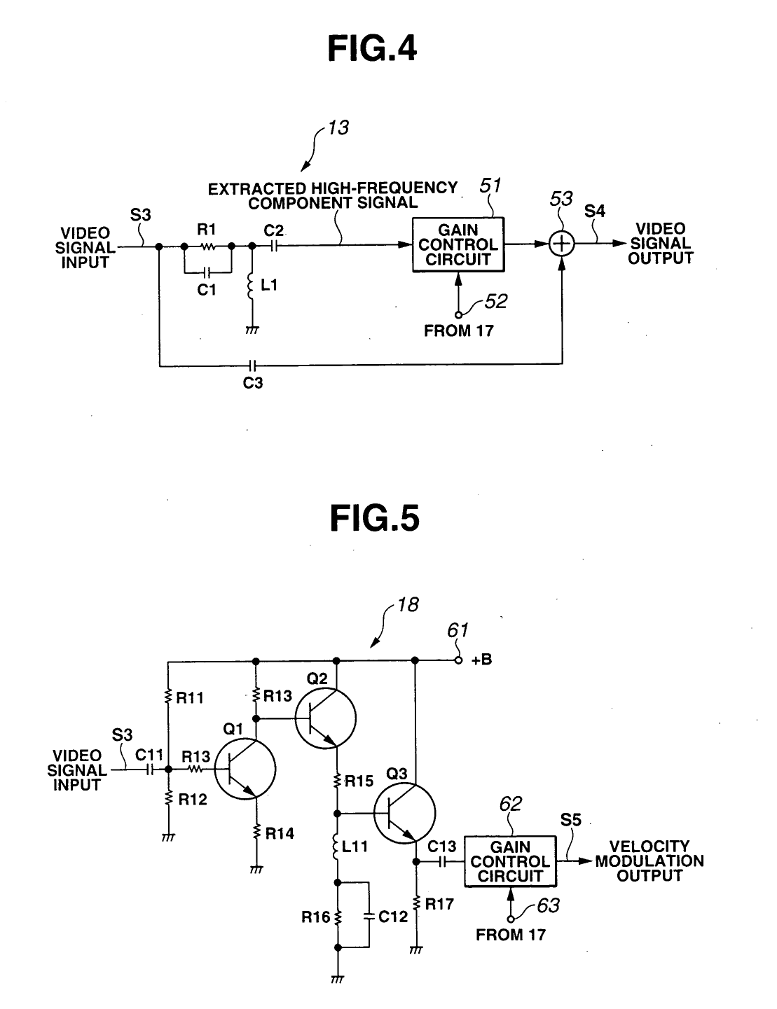

FIG. 4 is a block diagram of the aperture correction circuit 13.

As shown in FIG. 4, in the aperture correction circuit 13, a high frequency component is first extracted from the analog-converted video signal S3 output from the noise reduction circuit 11 via the differentiating circuit including a coil L1 and a parallel circuit composed of a resistor R1 and a capacitor C1 and via a coupling capacitor C2. Then, the amplitude level of the high frequency component signal is controlled so as to be an appropriate level when going through a gain control circuit 51 and is input to one input terminal of an adder 53 as an aperture correction signal for outline enhancement. Additionally, the microprocessor 17 supplies a control signal in accordance with the noise detection value to a control terminal 52 of the gain control circuit 51. Upon receiving the control signal, the gain control circuit 51 outputs the aperture correction signal for outline enhancement in accordance with the noise detection value. The original video signal S3 is input to the other input terminal of the adder 53 via a coupling capacitor C3. The adder 53 adds a correction signal (aperture collection value) from the gain control circuit 51 in accordance with the noise detection value to the original video signal S3. The resultant signal is output as an aperture-corrected video signal S4.

When the level detection value S2 from the noise detection circuit 9 exceeds a predetermined value, the microprocessor 17 controls the correction signal level (aperture correction value) of the gain control circuit 51 to decrease. When the level detection value S2 from the noise detection circuit 9 decreases under a predetermined value, the microprocessor 17 controls the correction signal level (aperture correction value) of the gain control circuit 51 to increase.

FIG. 5 is a block diagram of the differentiating circuit 18 in the velocity modulation circuit 20.

As shown in FIG. 5, in the differentiating circuit 18, the analog-converted video signal S3 from the noise reduction circuit 11 is input to a base of an amplifier transistor Q1 via a coupling capacitor C11 and an input resistor R13. A DC voltage of a power supply terminal 61 of a DC power supply +B is divided by a resistor R11 and a resistor R12 and the divided voltage is supplied to the base of the transistor Q1 via the resistor R13. A collector of the transistor Q1 is connected to the power supply terminal 61 via a collector resistor R13. An emitter of the transistor Q1 is connected to a reference potential point via an emitter resistor R14.

The collector output amplified by the amplifier transistor Q1 is input to a base of the transistor Q2. A collector of the transistor Q2 is connected to the power supply terminal 61. An emitter of the transistor Q2 is connected to the reference potential point via a differentiating circuit composed of a resistor R15 and a coil L11 and a parallel circuit composed of a resistor R16 and a high-frequency compensation capacitor C12. The differentiating circuit is connected in series to the parallel circuit. A first-order differential signal of the input video signal appears at a connection point between the resistor R15 and the coil L11 in the differentiating circuit. The differential signal is input to a base of an output transistor Q3 at the next stage. A collector of the transistor Q3 is connected to the power supply terminal 61. An emitter of the transistor Q3 is connected to the reference potential point via an emitter resistor R17. In other words, the output transistor Q3 and the emitter resistor form an emitter follower circuit.

A differential signal output from the emitter of the output transistor Q3 is used for horizontal scanning velocity modulation and is input to a gain control circuit 62 at an output stage via a coupling capacitor C13. A control signal in accordance with the noise detection value from the microprocessor 17 is supplied to a control terminal 63 of the gain control circuit 62. Thus, the gain control circuit 62 outputs a differential signal S5 for horizontal scanning velocity modulation in accordance with the noise detection value. The differential signal S5 for horizontal scanning velocity modulation is power-amplified by the drive circuit 19 for power amplification and is supplied to the velocity modulation coil 21.

When the level detection value S2 from the noise detection circuit 9 exceeds a predetermined value, the microprocessor 17 controls an output gain for velocity modulation of the gain control circuit 62 to decrease. When the level detection value S2 from the noise detection circuit 9 decreases under a predetermined value, the microprocessor 17 controls the output gain for velocity modulation of the gain control circuit 62 to increase.

In the above-described embodiment, a noise reduction device of a television receiver is described. However, the present invention is not limited thereto. The present invention can be applied to a noise reduction device of video equipment, such as a VTR and a video camera.

Having described the embodiments of the invention referring to the accompanying drawings, it should be understood that the present invention is not limited to those precise embodiments, and various changes and modifications thereof could be made by one skilled in the art without departing from the spirit or scope of the invention as defined in the appended claims.

1. A noise reduction device comprising:
a noise reduction unit which reduces noise by carrying out an arithmetic operation on an input video signal and one of a frame-delayed signal and a field-delayed signal of the video signal;
a unit which maintains the noise reduction unit at a constant noise reduction level at all times;
a noise detection unit which detects a noise level of the video signal;
an aperture correction unit which corrects image quality using a high-frequency component extracted from the video signal as a correction signal;
a velocity modulation unit which corrects image quality by supplying the high-frequency component extracted from the video signal to an auxiliary deflecting coil of a cathode ray tube as a scanning velocity modulation signal; and
a control unit which controls a level of the correction signal of the aperture correction unit and a level of the scanning velocity modulation signal of the velocity modulation unit in accordance with the detection level of the noise detection unit.

2. The noise reduction device according to claim 1, wherein the control unit controls a level of a correction signal of the aperture correction unit and a level of the scanning velocity modulation signal of the velocity modulation unit so as to decrease the levels when the detection level of the noise detection unit is higher than a predetermined value and so as to increase the levels when the detection level of the noise detection unit is lower than a predetermined value.

3. A television receiver comprising:
a cathode ray tube comprising a deflecting coil and an auxiliary deflecting coil for scanning velocity modulation;
a noise reduction circuit which reduces noise by carrying out an arithmetic operation on an input video signal and one of a frame-delayed signal and a field-delayed signal of the video signal and maintains a noise reduction level to be a constant value;
a noise detection circuit which detects a noise level of the video signal;
an aperture correction circuit which corrects image quality using a high-frequency component extracted from the video signal as a correction signal;
a velocity modulation circuit which corrects image quality by supplying a high-frequency component extracted from the video signal to the auxiliary deflecting coil as a scanning velocity modulation signal; and
a control circuit which controls a level of the correction signal of the aperture correction circuit and a level of the scanning velocity modulation signal of the velocity modulation circuit in accordance with the detection level of the noise detection circuit.

4. The television receiver according to claim 3, wherein the noise detection circuit detects a video level during an inactive video period of the video signal.

5. The television receiver according to claim 3, wherein the aperture correction circuit comprises an extraction circuit which extracts a high-frequency component from a video signal, a first gain control circuit which is connected in series to the extraction circuit, and an adder which adds the high-frequency component corrected by the first gain control circuit to the video signal, and the aperture correction circuit controls a gain of the first gain control circuit in response to a control signal from the control circuit.

6. The television receiver according to claim 3, wherein the velocity modulation circuit comprises a differentiating circuit which differentiates a high-frequency component of a video signal and a second gain control circuit which is connected in series to the differentiating circuit, and the velocity modulation circuit controls a gain of the second gain control circuit in response to a control signal from the control circuit so as to control a differential output level.

7. A noise reduction device comprising:
a noise reduction unit which reduces a noise components signal from an input video signal in a constant gain, the noise components signal is extracted by difference between current input signal and a preceding video signal;
a detection unit which detects a noise level of the input video signal;
a correction unit which corrects image quality using a high-frequency component extracted from the video signal as an outline enhancement correction signal;
a modulation unit which corrects image quality by supplying the high-frequency component extracted from the video signal to an auxiliary deflecting coil of a cathode ray tube as a scanning velocity modulation signal; and
a control unit which controls a correction gain of at least one of the correction unit or the velocity modulation unit so as to inverse proportion to noise level.
